(19) United States
(12) Patent Application Publication
(10) Pub. No.: US 2024/0050795 A1
(43) Pub. Date: Feb. 15, 2024

(54) Anchor Attachment for Resistance Band Training on Power Racks

(71) Applicant: Chun Sik Chae, South San Francisco, CA (US)

(72) Inventor: Chun Sik Chae, South San Francisco, CA (US)

(21) Appl. No.: 18/470,270

(22) Filed: Sep. 19, 2023

(51) Int. Cl. A63B 21/055; A63B 21/04

(52) U.S. Cl. CPC A63B 21/0557; A63B 21/0442

(57) ABSTRACT

This patent application discloses an innovative attachment system designed to connect resistance bands to exercise apparatuses. Comprising two main components, including an anchor with diverse designs, a flange, and a threaded bolt, the attachment system offers versatile options for exercise enthusiasts. Additionally, a complementary part featuring a wing nut and a matching flange ensures secure attachment to exercise equipment like power racks with varying hole sizes. Crafted from durable materials like steel, stainless steel, aluminum, copper, titanium, or their alloys, this attachment system combines durability with ease of use, facilitating resistance-band workouts, dynamic bodyweight training systems, and more. Its versatility, portability, and simplicity of design make it a valuable addition to the fitness equipment landscape.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates to equipment for physical exercise, in particular to an anchor attachment with diverse designs encompassing variations featuring rings and hooks for power racks and other similar exercise apparatuses.

### Description of the Related Art

The health benefits of physical exercise are widely known. Generally, various types of exercise equipment have been proposed for different exercise motions, for instance, the treadmill machine, the stationary bike, the elliptical, or other gym apparatuses for fitness and muscle exercises. Most of those devices on the market usually concentrate on aerobic training via working the legs in some form. Some of those machines permit a user to exercise a given muscle group of the upper body via some sort of resistance mechanism such as elastic bands attached to a pair of handles.
multi-functional weight training equipment which enables multiple exercise routines in various positions on a single machine has been designed in the past. Exercise devices that have been prevalent in recent years, commonly known as functional trainers, use adjustable components in order to create new positions for exercise. Thanks to their ability to transform themselves into different configurations, they can mimic most of the traditional multi-station machines and free weights with just a few adjustments. There are many types of functional trainers on the market today, and they use several different methods for adjusting their components. Most of them use adjustable arms, sliding carriages with pulleys, or multiple pulleys mounted at different locations on the machine.

Also, some of them can be used with the workout bench. The number of exercises that can be performed on a particular machine depends on how many different configurations it can be transformed into. More configurations provide more exercise options for the user. The goal is to create as many new positions for exercise as possible with the use of a single machine. Because low cost, easily use, and function, the resistance band has become the main tool in individual training and physiotherapy. Since its simple, cheap design element and wide range of gymnastics and therapeutic applications, the resistance band has become a standard component of exercise equipment, frequently utilized in both bodybuilding and therapeutic contexts within the fitness and healthcare specialties

Multiple solutions have been presented in the prior art regarding efficient exercise systems. The current invention proposes a unique system that features an enhanced standalone way of supporting, collating, handling, and facilitating a person while using various exercise apparatuses. The system includes multi-shaped anchor attachments including variations featuring rings and hooks for power racks wherein the proposed assembly is made of metals selected from the group consisting of steel, stainless steel, aluminum, copper, titanium, and their alloys. The assembly includes a receiving portion that is in the form of a ring, a hook, or any other shape that can perform the required functionality. The user can add the resistance band, once the assembly is installed within power racks to perform exercise.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to an advancement in exercise machine attachment that provides an advancement in its own way.

It is also the main objective of the invention to provide multi-shaped anchor attachments including variations featuring ring and hook-shaped attachments for power racks and resistance bands.

It is a further objective of the invention to provide an assembly made of metals selected from the group consisting of steel, stainless steel, aluminum, copper, titanium, and their alloys to provide durability and long-lasting performance to the user.

It is moreover the objective of the invention to assist in including but not limited to resistance-band workouts with power racks, dynamic bodyweight training systems, and other items.

It is also the objective of the invention to provide a unitary or standalone commercial-grade exercise support attachment that can be designed in multiple shapes including but not limited to ring, hook-shaped, and other suitable shapes.

Another object of the invention is to provide easy installation and position adjustment at any time wherein installation is as easy as finding a hole to install and tightening two parts.

It is the further objective of the present invention to provide the simplicity of its design.

It is also the objective of the invention to provide portability. Being detachable and light-in-weight enables a user to take it on business trips, vacations, and the like so that an exercise schedule is not interrupted by such trips.

This Summary is provided merely for the purposes of summarizing some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a complete view of the present invention.

FIG. 2 shows the front view of the assembly.

FIG. 3 is a complete view of the complete assembly.

FIG. 4 is the bottom view of the assembly.

FIG. 5 is another bottom view of the complete assembly.

FIG. 6 shows an exploded view of the assembly.

FIG. 7 shows another configurational view of the assembly.

FIG. 8 shows the installed view of the assembly.

FIG. 9 shows a perspective view of the assembly.

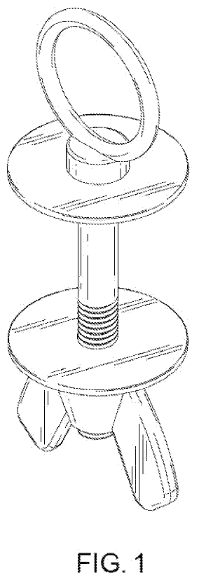

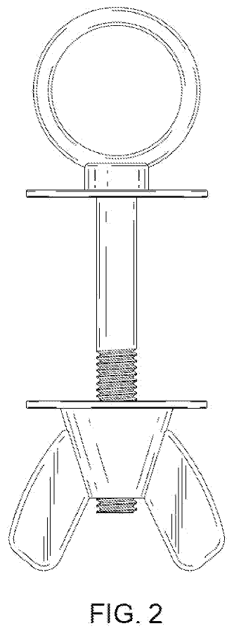

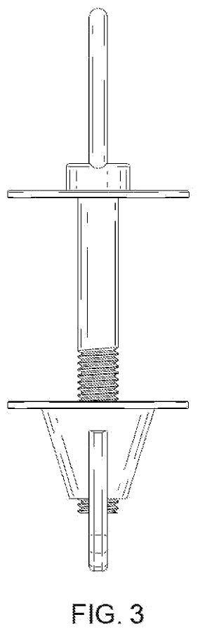

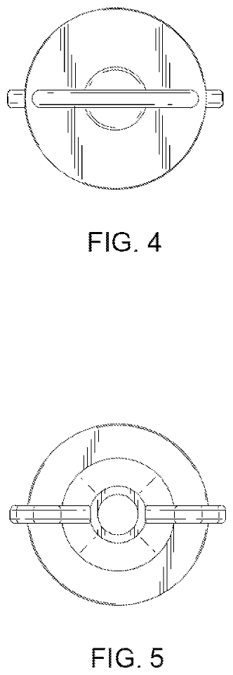

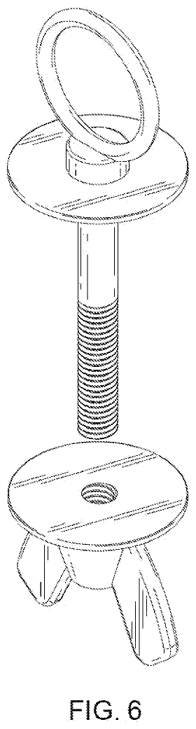

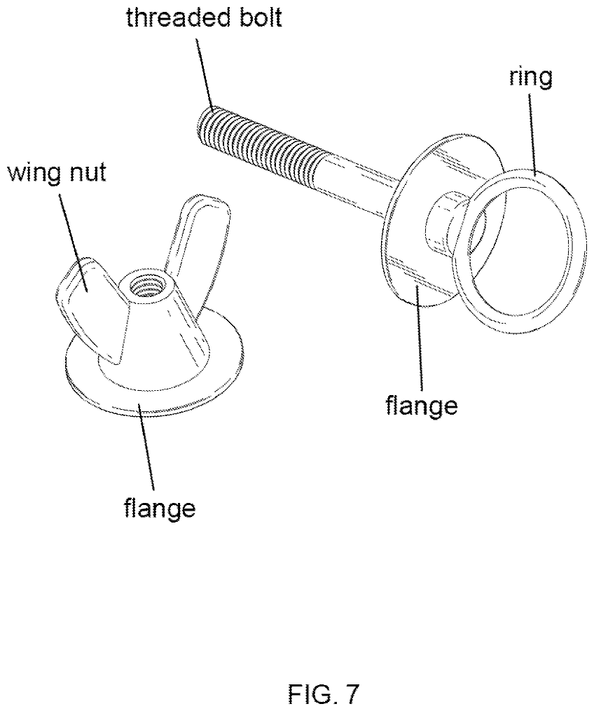

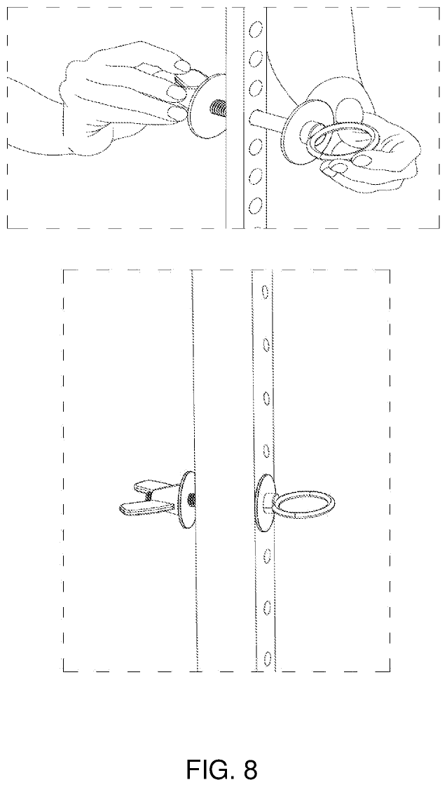

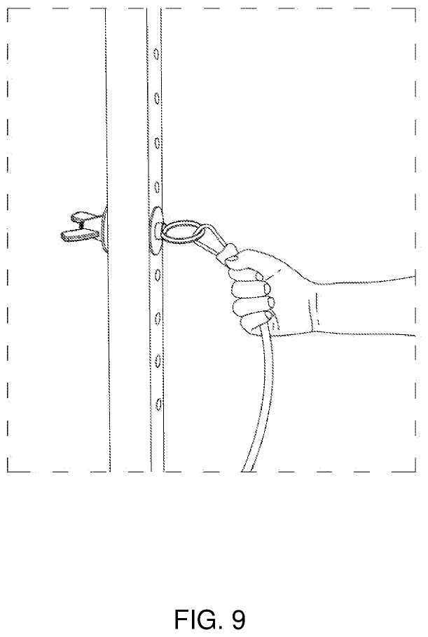

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

Resistance bands are popular pieces of strength training equipment that allow individuals to build and tone their muscles with a simple elongated strap. Most resistance bands are made from a durable rubber strap or an elongated piece of elastic able to withstand repeated stretching and relaxing. Many people enjoy the convenience of utilizing the bands because they are easy to store and transport compared to conventional strengthening pieces like barbells, kettlebells, or hand weights. Because they are flexible, elongated straps, people can easily take the bands wherever they go for an instant workout.

The current invention aims to provide an attachment that can be used to connect resistance band products. It is used for various exercise units. The assembly can be attached to power rack beams that have various beam sizes and hole sizes. As the attachment has a flange and a bolt system, it makes it widely acceptable for various types of squat racks. The anchor attachment consists of two parts. Part 1 includes an anchor of diverse designs, encompassing variations featuring rings and hooks, the flange, and the bolt part (Threaded bolt). Part 2 includes a flange the same size as the one in Part 1 with the wing nut. Furthermore, the flange and wing nut make the product stay attached when used with holes of beams of power racks or any gym equipment featuring various hole sizes.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: An attachment to connect the resistance band for power racks comprising:
A main part; and,
A second part.
The attachment as per claim 1, wherein the first part includes an anchor portion with diverse designs (i.e., a ring, a hook, or any other anchor), a flange, and a threaded bolt that can be used as an anchor to connect resistance band.
The attachment as per claim 1, wherein the second part includes wing nut and flange.
The attachment as per claim 1, wherein the attachment can be used to connect resistance band product.
The attachment as per claim 1, wherein the flange and the wing nut part makes the product stay attached with the main part when it is used with holes of beams of power racks featuring a range of hole sizes.
